(19) United States
(12) Patent Application Publication
(10) Pub. No.: US 2014/0333226 A1
(43) Pub. Date: Nov. 13, 2014

(54) MR16 GU5.3 DIMMABLE LAMP

(71) Applicant: LEDZWORLD SDN. BHD., (US)

(72) Inventors: Ragbir Singh, Ipoh (MY); Deepak Ken Chakravarti, Penang (MY); Say Joo NG, Penang (MY)

(73) Assignee: LEDZWORLD SDN. BHD., PENANG (MY)

(21) Appl. No.: 13/891,055

(22) Filed: May 9, 2013

(51) Int. Cl. H05B 33/08

(52) U.S. Cl. CPC H05B 33/0809
USPC 315/282; 315/246

(57) ABSTRACT

A light source for producing variable illumination coupled to at least one device includes a light chip assembly, and an LED driver module. The light chip assembly includes multiple LEDs on a silicon substrate, a heat-sink coupled to the light chip assembly, the silicon substrate being coupled to an inner core region of the heat-sink via a thermally conductive adhesive. The LED driver module includes housing, a load stabilization LED driver circuit within the housing, the load stabilization LED driver circuit being configured to drive the light chip assembly, a printed circuit coupled to the load stabilization LED driver circuit and a power supply for providing an alternating current.

### BACKGROUND OF THE INVENTION

1. Field of the Invention

Embodiments of the present invention relate to MR16 GU5.3 dimmable lamp based on LED technology, and more particularly, to a fully dimmable and compatible MR16 GU5.3 light source and methods thereof.

2. Description of the Related Art

Around the world there has been growing concern to save energy and to find alternatives to replace the conventional illumination technologies. In many countries, and in many states, incandescent bulbs are being replaced, and more efficient lighting sources mandated. Alternative light sources include fluorescent tubes, halogen, and light emitting diodes (LEDs). Despite the availability and improved efficiencies of these options, many people are reluctant to switch to these alternative light sources.

However, the newer technologies have not been widely embraced for various reasons. One such reason is the use of toxic substances in the lighting source. As an example, fluorescent lighting sources typically rely upon mercury in a vapor form to produce light. Because the mercury vapor is a hazardous material, spent lamps cannot simply be disposed of at the curbside, but must be transported to designated hazardous waste disposal sites. Additionally, some fluorescent tube manufacturers instruct the consumer to avoid using the bulb in sensitive areas of the house such as bedrooms.

Another reason for the slow adoption of alternative lighting sources is its low performance compared to the incandescent light bulb. Fluorescent lights rely upon a separate starter or ballast mechanism to initiate the illumination. Thus they sometimes do not turn on “instantaneously” as consumers expect. In addition fluorescent lights typically do not immediately provide light at full brightness, instead ramping up to full brightness over time. Further, most fluorescent lights are fragile, are not capable of dimming, have ballast transformers that can be noisy, and can fail if cycled on and off frequently.

Another type of alternative lighting source more recently introduced relies on the use of light emitting diodes (LEDs). LEDs have advantages over fluorescent lights including the robustness and reliability inherent in solid state devices, the lack of toxic chemicals that can be released during accidental breakage or disposal, instant-on capabilities, dimmability, and the lack of audible noise. With the advent of Light emitting diode (LED) related technologies having the advantages of energy efficiency and low power consumption focus of many research and development departments have shifted towards researching in LED related technologies. Currently, the present demand for LED lamps is growing and MR16 GU5.3 is the most challenging product to be designed in ANSI (American National Standard Institution) dimension due to various reasons specifically related to compatibility and thermal. The main challenges faced are on the compatibility with various standard dimmers (leading, trailing and universal) and electronic transformers which are presently installed in professional and residential applications.

Another aspect is to satisfy the demands for dimming control and ambient lighting. Over the years, LED related technologies have become significant technologies ever since the consumers have realized that the LED not only provides the illumination but also contributes to power saving. To fulfil the demands of the consumers for practical applications, the design of dimming control and ambient lighting have become crucial to the market of LED fixtures. Yet another aspect is to reduce the cost of LED fixtures. The dimmable LED fixture is composed of a dimming unit and an LED fixture. For indoor lighting applications that require dimming function to control each unit, the cost will be increased inevitably.

Moreover, majority of existing dimmers and transformers are designed to be functional for halogen, CFL and incandescent lamp. These lamps are resistive based where by the loading factor satisfies dimmers and transformers operational requirement. Currently the solution to the compatibility of MR16 GU5.3 LED based lamps is very immature as a direct retrofit replacement. There is no proven integrated circuit or solution that has been developed by semiconductor industry to address the compatibility issue.

The current state of the art technologies employ active cooling systems such as mechanical fans. The present technology available in the market employ fan to cool down the loading factor which is thermally critical for MR16 GU5.3 design. However, adding an active cooling system such as fan does not automatically solve the compatibility towards the transformers and dimmers. The present semiconductor technology has not matured with correct understanding of dimmers and transformers operational characteristic. As such much of the design is being done in discrete form together with specific integrated circuit application. Due to ANSI dimension boundary for the overall product dimension, much of the discrete technology is unable to be integrated to smaller form factor of PCBA (Printed circuit board Assembly) that is required by the ANSI standard until the semiconductor industry creates a breakthrough design for the dimmer and transformer compatibility as integrated circuit.

Accordingly, there remains a need in the art for LEDs based technologies that obviate the usage of mechanical fan as active cooling system. Currently, there is no single proven solution for MR16 according to ANSI dimension without an active cooling system.

Accordingly, there exists a need in the art for light source having the driver characterization design to suit thermal requirement and compatibility across the standard dimmer and transformers.

Accordingly, there exists a need in the art for intelligent solutions to detect transformer and dimmer operating characteristic, which address the limitations of the prior art.

### SUMMARY OF THE INVENTION

Embodiments of the present disclosure, generally, disclose a light source for producing variable illumination coupled to at least one device includes a light chip assembly, and an LED driver module. The light chip assembly includes multiple LEDs on a silicon substrate, a heat-sink coupled to the light chip assembly, the silicon substrate being coupled to an inner core region of the heat-sink via a thermally conductive adhesive. The LED driver module includes housing, a load stabilization LED driver circuit within the housing, the load stabilization LED driver circuit being configured to drive the light chip assembly, a printed circuit coupled to the load stabilization LED driver circuit and a power supply for providing an alternating current.

Another embodiments of the present disclosure, generally, disclose a method for forming a light source for producing variable illumination coupled to at least one device, includes the steps of providing an LED package assembly having a multiple LEDs disposed on a silicon substrate electrically coupled to a first flexible printed circuit, bonding the LED package assembly directly to a heat-sink via a thermally conductive adhesive, providing a LED driver module having a load stabilization LED driver circuit on a printed circuit, the load stabilization LED driver circuit and the printed circuit being disposed within a thermally conductive base, applying power supply for providing an alternating current to the LED driver module, receiving the alternating current from the power supply and transforming the alternating current into an input voltage, and receiving the input voltage from the transformer and the load stabilization LED driver circuit being configured to produce varying levels of regulated current for the multiple LEDs.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an exploded perspective view of a light source for producing variable illumination coupled to one or more devices, in accordance with one embodiment of the present invention;

FIG. 2 illustrates a block diagram of the light source for producing variable illumination coupled to one or more devices, in accordance with one embodiment of the present invention; and

FIG. 3A graphically illustrates a trailing edge phase control for the light source for producing variable illumination coupled to one or more devices, in accordance with one embodiment of the present invention;

FIG. 3B graphically illustrates a leading edge phase control for the light source for producing variable illumination coupled to one or more devices, in accordance with one embodiment of the present invention;

FIG. 4A illustrates a top layer PCB layout of the load stabilization LED driver circuit for producing variable illumination coupled to one or more devices, in accordance with one embodiment of the present invention;

FIG. 4B illustrates a bottom layer PCB layout of the load stabilization LED driver circuit for producing variable illumination coupled to one or more devices, in accordance with one embodiment of the present invention;

FIG. 5A illustrates a circuit diagram of the load stabilization LED driver circuit, in accordance with one embodiment of the present invention;

FIG. 5B illustrates a circuit diagram of the load stabilization LED driver circuit, in accordance with one embodiment of the present invention;

FIG. 5C illustrates a circuit diagram of the load stabilization LED driver circuit, in accordance with one embodiment of the present invention;

FIG. 5D illustrates a circuit diagram of the load stabilization LED driver circuit, in accordance with one embodiment of the present invention;

FIG. 5E illustrates a circuit diagram of the load stabilization LED driver circuit, in accordance with one embodiment of the present invention; and

FIG. 6 illustrates a flow diagram of a method for forming a light source for producing variable illumination coupled to one or more devices, in accordance with one embodiment of the present invention.

While the fully dimmable and compatible MR16 GU5.3 light source and methods thereof are described herein by way of example for several embodiments and illustrative drawings, those skilled in the art will recognize that the present invention are not limited to the embodiments or drawings described.

It should be understood, that the drawings and detailed description thereto are not intended to limit embodiments to the particular form disclosed. Rather, the intention is to cover all modifications, equivalents and alternatives falling within the spirit and scope of the methods and systems for automated inspection utilizing direct encoder triggering for inspecting an object placed on a mechanical assembly.

Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Various embodiments of the present invention are aimed at providing LED based lamps with 80% compatibility to retrofit application. Moreover, the present invention addresses on how to electronically satisfy the transformers and dimmers operational requirement with correct loading factor while keeping the peak current under control. The present invention further improves upon the existing solution of a halogen system with reduce power consumption, high power factor and interoperability with various standard dimmers and transformers. More specifically, various embodiments of the present invention disclose that the loading factor switches efficiently in order to ensure the thermal characteristic of loading circuit is not extreme but reliable from thermal operating point.

In addition, various embodiments of the present invention are aimed at providing light source having in built circuit for handling the peak current during the dimming process. However, failing to control the peak current will cause a serious thermal problem which will lead to product failure.

Generally, various embodiments of the present invention is based on detecting the electronic source (E-Transformer) and dimmers required loading factor so that the transformers and dimmers are not upset at the operating curve when the lamp is dimmed gradually. In this way a linear dimming is achieved from maximum to minimum brightness. It is important that the electronic circuitry components are not overdriven beyond the limitation of the semiconductor junction temperature.

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

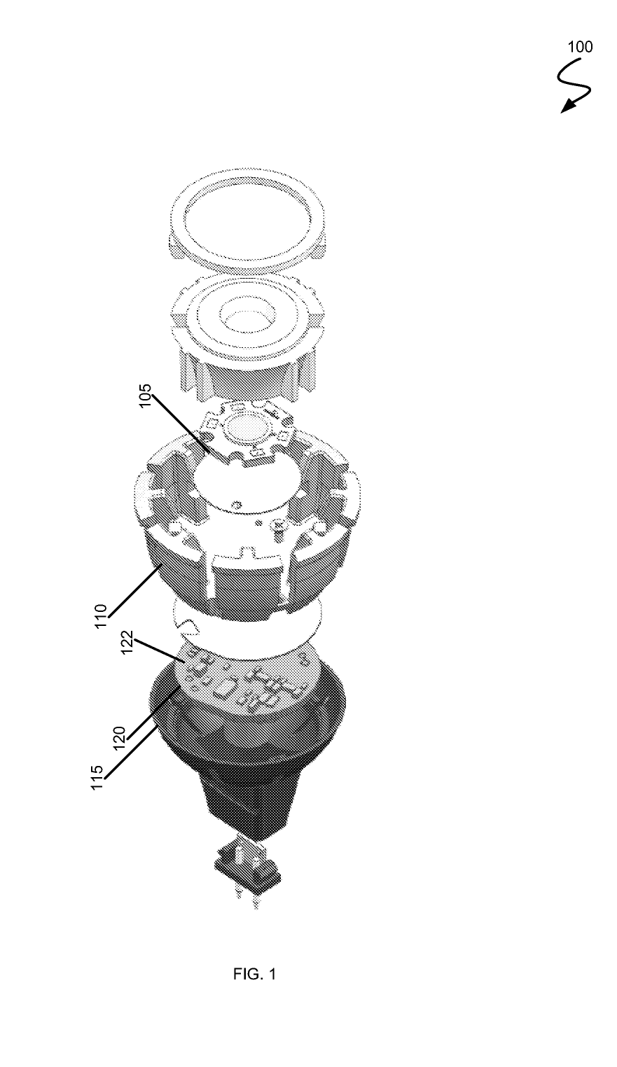

FIG. 1 illustrates an exploded perspective view of a light source 100 for producing variable illumination coupled to one or more devices, in accordance with one embodiment of the present invention. The light source 100 for producing variable illumination coupled to at least one device, a light chip assembly, and an LED driver module. The light chip assembly includes multiple LEDs 105 on a silicon substrate, a heat-sink 110 coupled to the light chip assembly. Particularly, the silicon substrate is coupled to an inner core region of the heat-sink 110 via a thermally conductive adhesive. The substrate is soldered to a flexible printed circuit substrate (FPC) having a pair of input power connectors. The silicon substrate is physically bonded to an MR16 form factor heat sink via thermal epoxy.

In accordance with one embodiment of the present invention, the LED driver module includes housing 115, a load stabilization LED driver circuit 120 within the housing 115. In operation, the load stabilization LED driver circuit 120 is configured to drive the light chip assembly, and a printed circuit is coupled to the load stabilization LED driver circuit 120 and a power supply 210 for providing an alternating current.

Moreover, the load stabilization LED driver circuit 120 includes multiple driving components disposed upon a first flexible printed circuit 122.

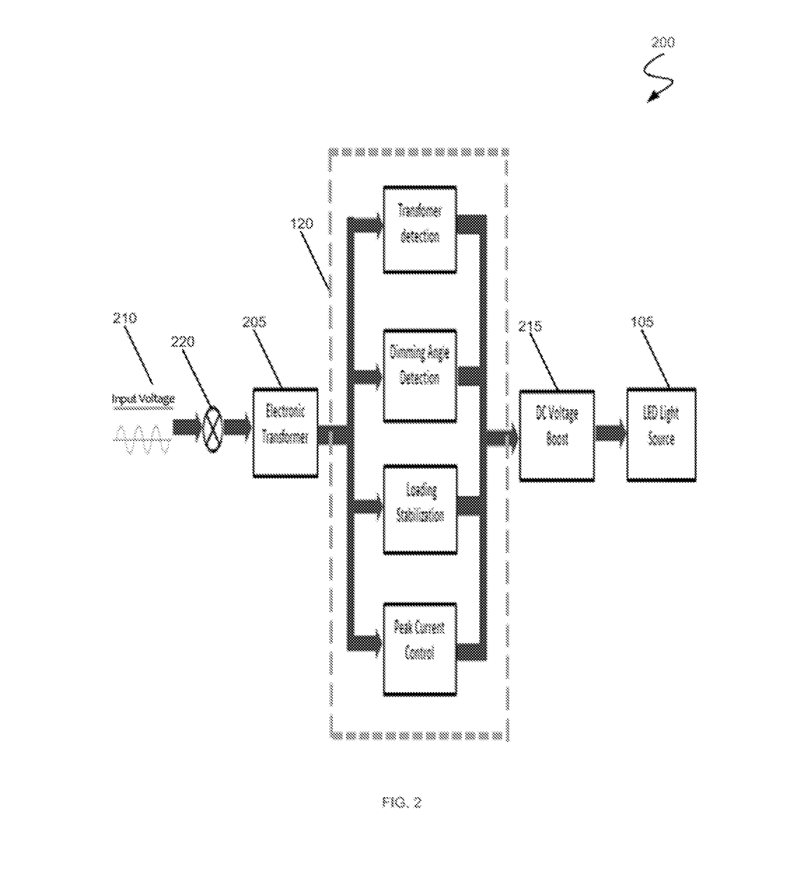

FIG. 2 illustrates a block diagram 200 of the light source 100 for producing variable illumination coupled to one or more devices, in accordance with one embodiment of the present invention. The LED driver module includes a transformer 205 for receiving the alternating current from the power supply 210 and transforming the alternating current into an input voltage. In operation, the load stabilization LED driver circuit 120 is electrically coupled to the transformer 205 for receiving the input voltage from the transformer 205 and producing varying levels of regulated current for the multiple LEDs 105.

In accordance with an embodiment of the present invention, the load stabilization LED driver circuit 120 detects the transformer 205 to operate in stabilization mode, and the load stabilization LED driver circuit 120 includes a dimming input. In operation, the dimming input detects a dimming angle to ensure efficient loading factor of at least one device, and controlling a peak current during dimming.

In accordance with an embodiment of the present invention, the at least one device is selected from a group consisting of dimmers, and transformer.

In accordance with an embodiment of the present invention, the light chip assembly further includes a voltage booster printed circuit 215 coupled to the silicon substrate and the voltage booster printed circuit 215 is electrically coupled to the load stabilization LED driver circuit 120. Moreover, the light chip assembly further includes a transducer 220 coupled to the power supply 210 and the transformer 205. Furthermore, the load stabilization LED driver circuit 120 is a thermal protection circuitry, and the thermal protection circuitry is configured for linear dimming.

In accordance with an embodiment of the present invention, the load stabilization LED driver circuit 120 is operated in the range of lighting intensity between 3% and 100% brightness.

In accordance with an embodiment of the present invention, the transducer 220 is an indicator lamp.

In accordance with an embodiment of the present invention, the light source 100 generates luminous efficacy greater than approximately 500 lumens.

In accordance with an embodiment of the present invention, the heat sink includes an MR-16 compatible heat sink.

In accordance with an embodiment of the present invention, the housing includes a GU5.3 compatible base.

In accordance with an embodiment of the present invention, a power consumption of the light source is approximately 10 watts.

In accordance with an embodiment of the present invention, the light source has a compatibility of about 80% to the at least one device.

In accordance with an embodiment of the present invention, the load stabilization LED driver circuit has a power factor of about 0.95.

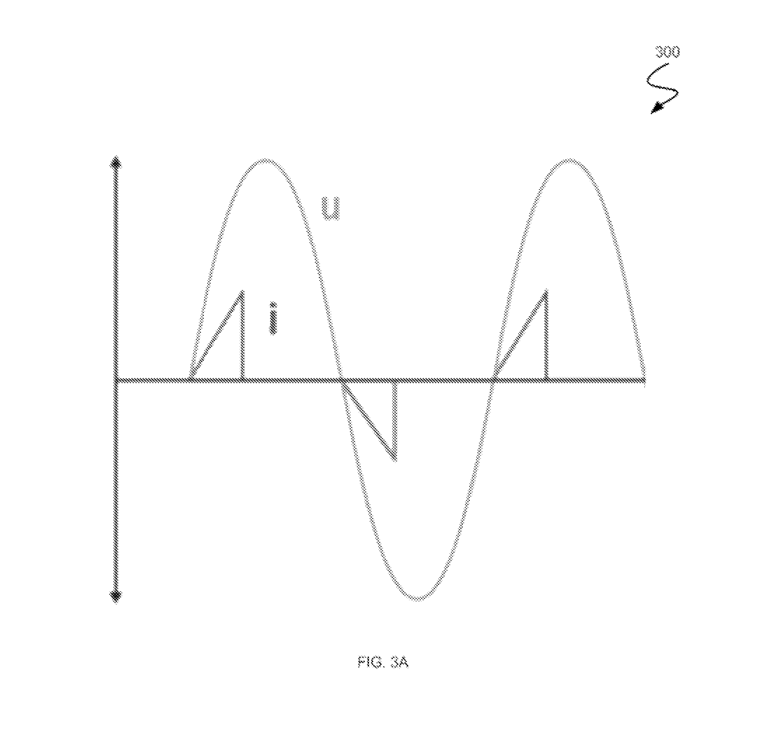

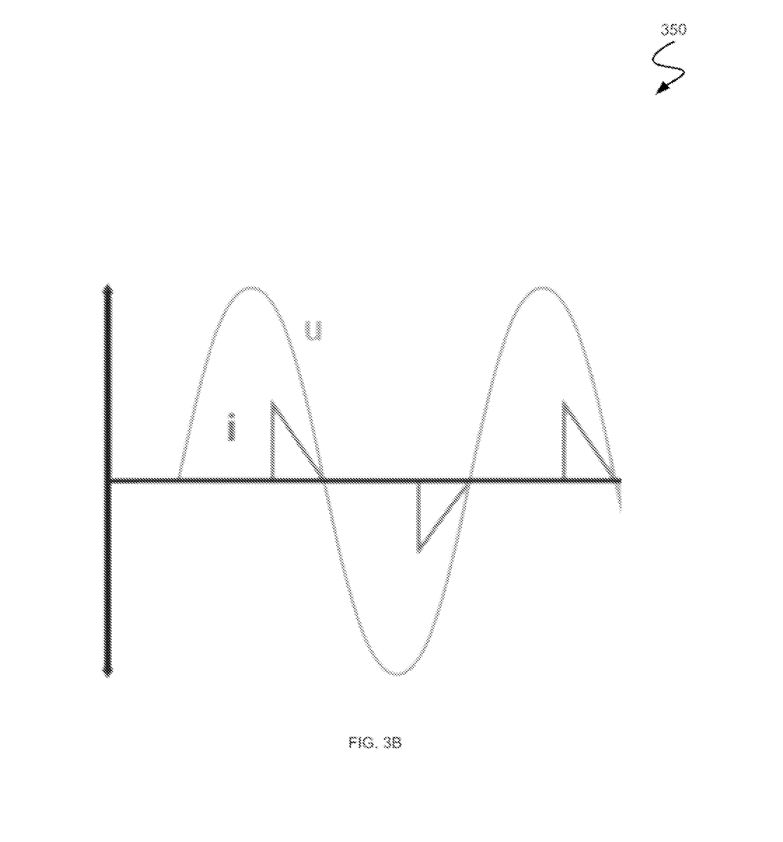

FIG. 3A graphically illustrates a trailing edge phase control 300 for the light source 100 for producing variable illumination coupled to one or more devices, and FIG. 3B graphically illustrates a leading edge phase control 350 for the light source 100 for producing variable illumination coupled to one or more devices, in accordance with one embodiment of the present invention. The symbol “i” is the current source and the symbol “u” is the voltage source. The supply of power signal is controlled by the trailing edge phase control and the leading edge phase control.

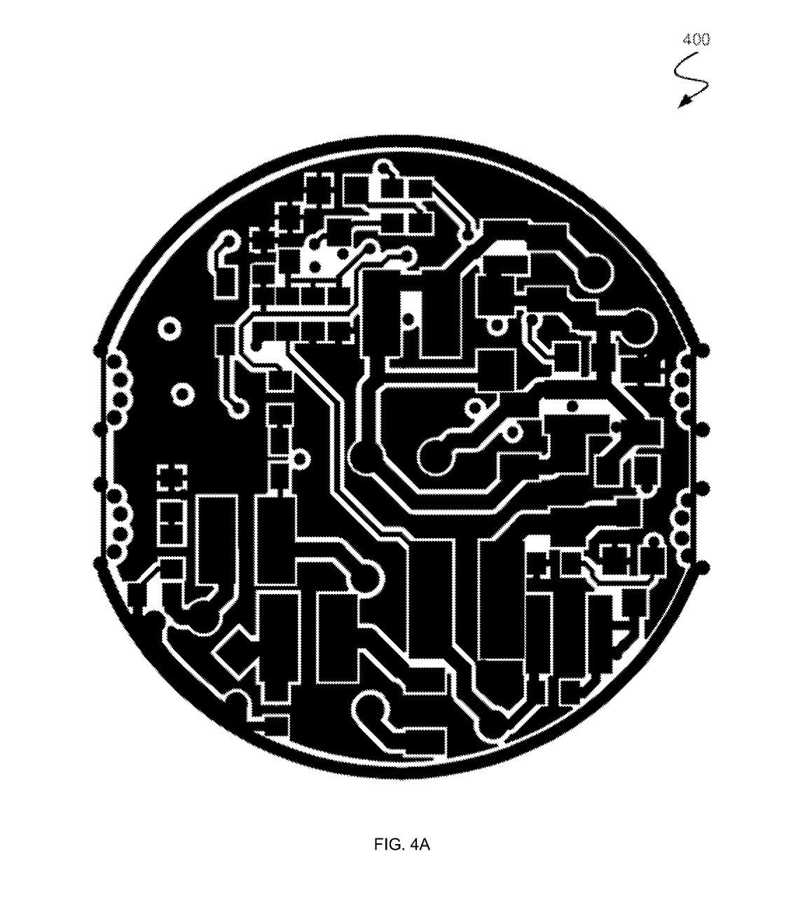

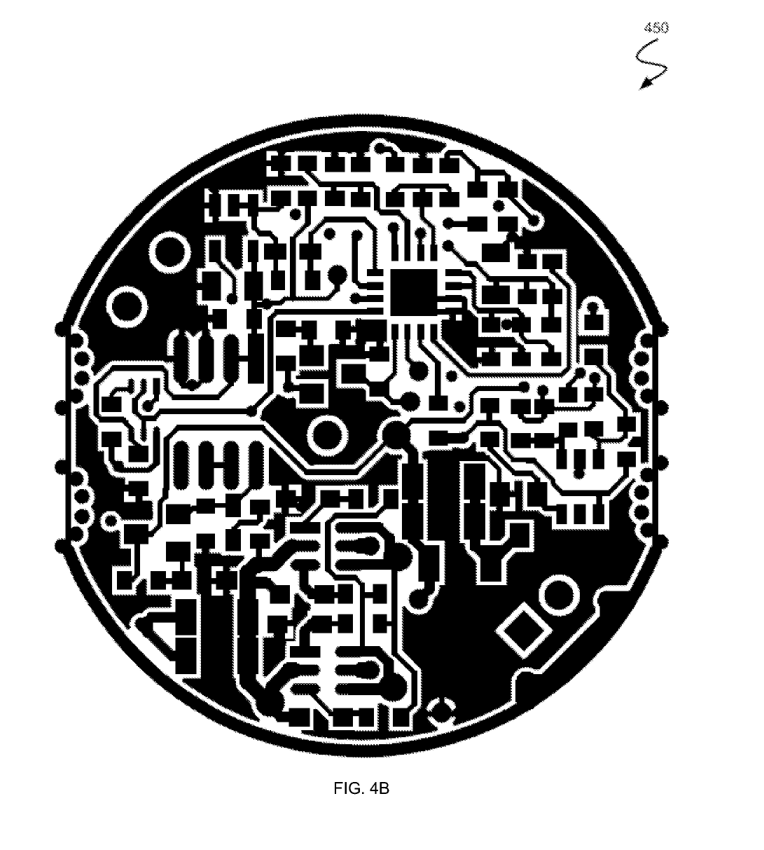

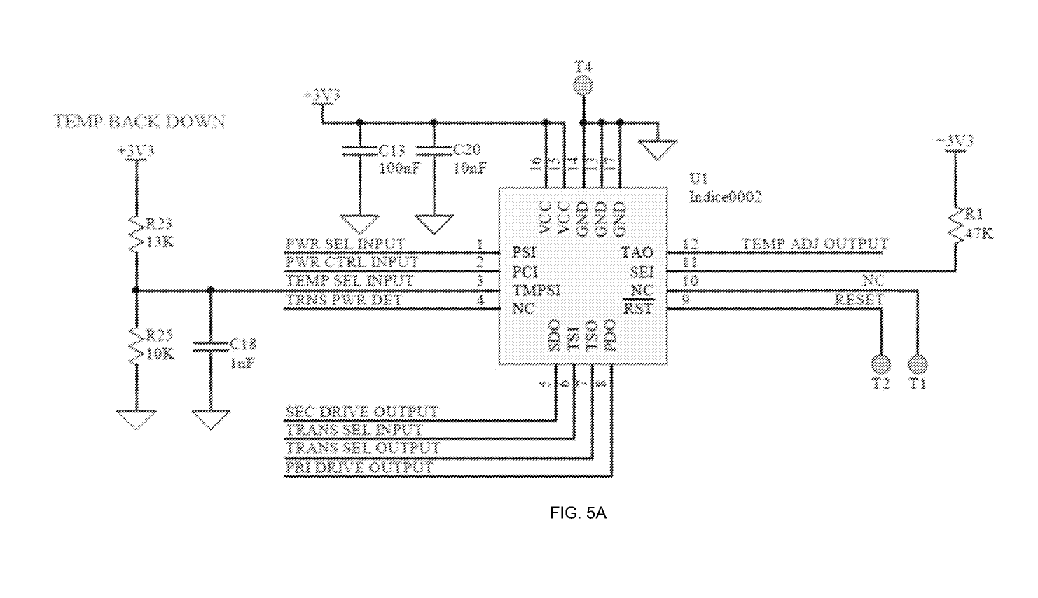

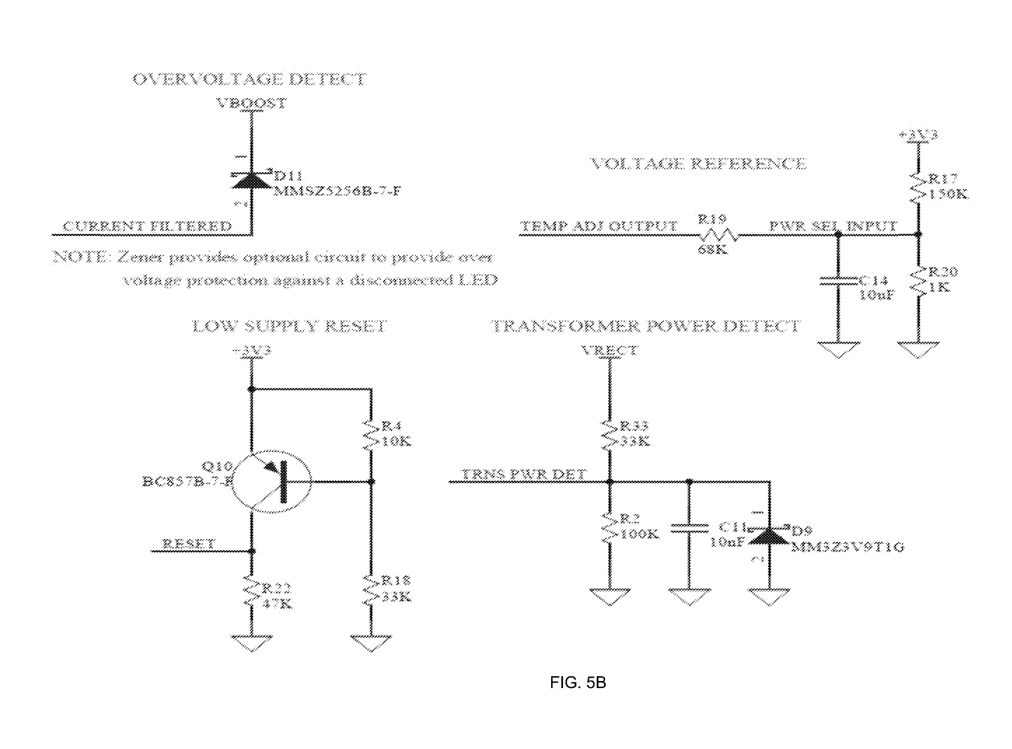

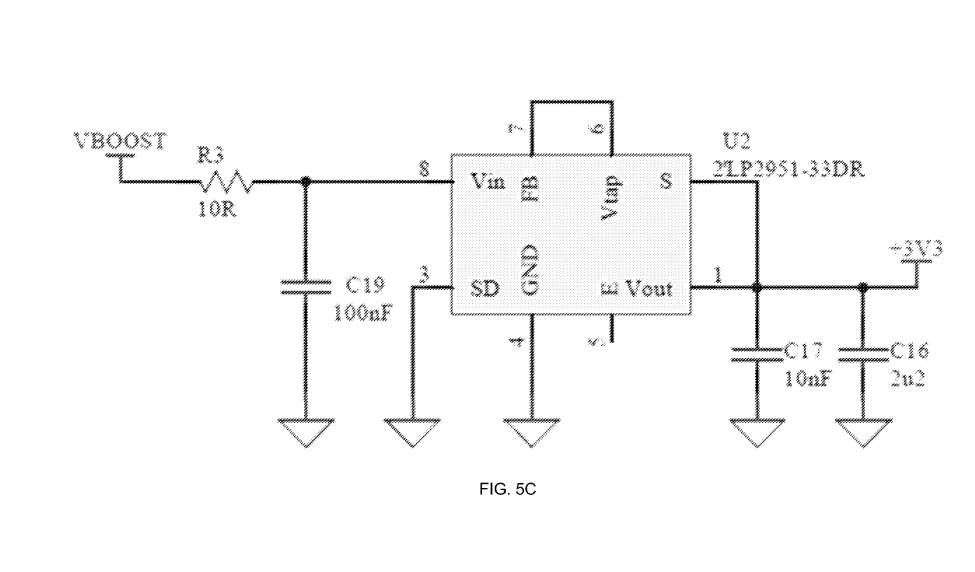

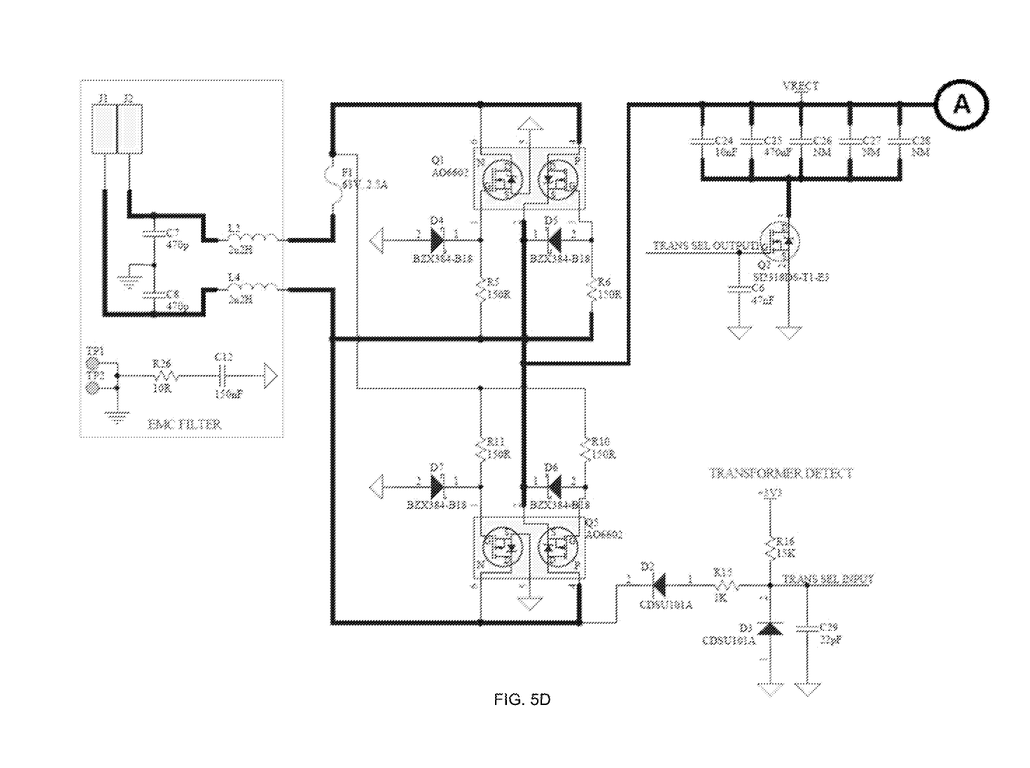

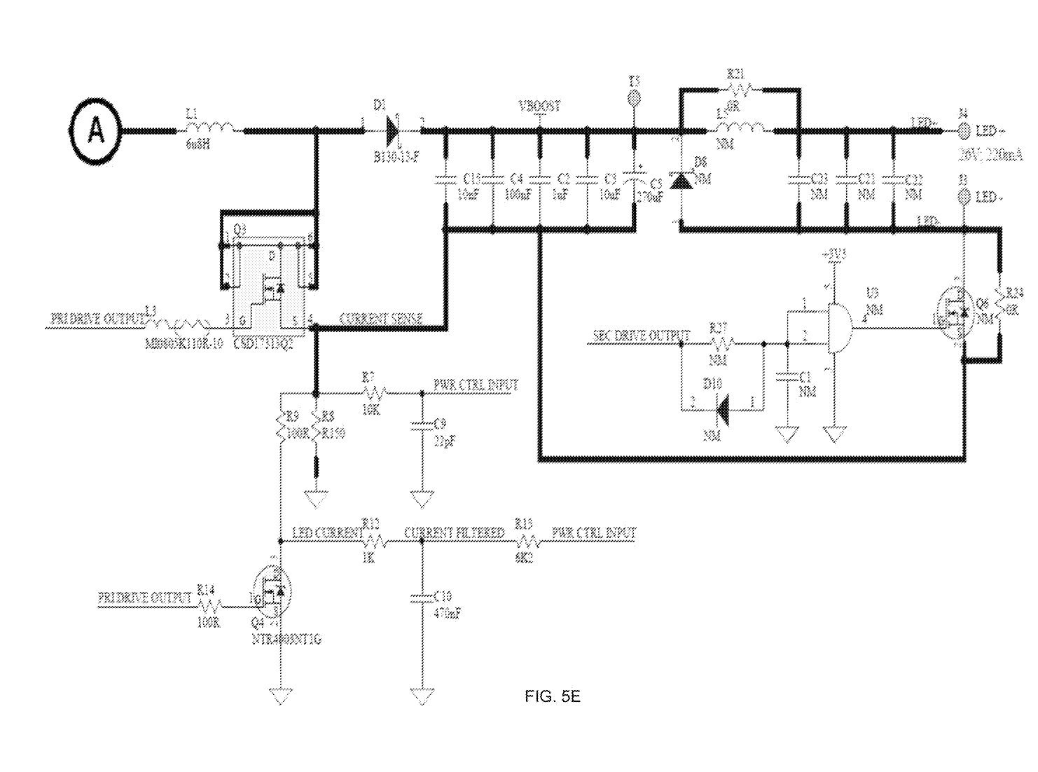

FIG. 4A illustrates a top layer PCB layout 400 of the load stabilization LED driver circuit 120 for producing variable illumination coupled to one or more devices, FIG. 4B illustrates a bottom layer PCB layout 450 of the load stabilization LED driver circuit 120 for producing variable illumination coupled to one or more devices, in accordance with one embodiment of the present invention. FIG. 5A and FIG. 5B illustrates a circuit diagram 500 of the load stabilization LED driver circuit 120, in accordance with one embodiment of the present invention. FIG. 5C, FIG. 5D and FIG. 5E illustrates a circuit diagram of the load stabilization LED driver circuit, in accordance with one embodiment of the present invention.

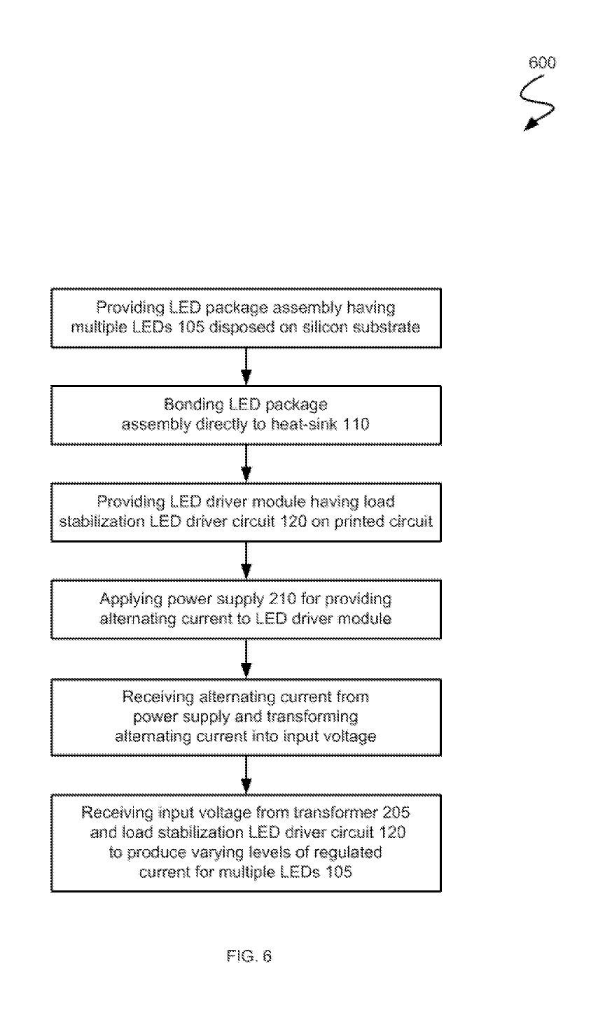

FIG. 6 illustrates a flow diagram of a method 600 for forming a light source for producing variable illumination coupled to one or more devices, in accordance with one embodiment of the present invention. The method 600 for forming a light source for producing variable illumination coupled to at least one device, includes the steps of providing an LED package assembly having multiple LEDs 105 disposed on a silicon substrate electrically coupled to a first flexible printed circuit 122, bonding the LED package assembly directly to the heat-sink 110 via the thermally conductive adhesive, providing a LED driver module having the load stabilization LED driver circuit 120 on a printed circuit. Particularly, the load stabilization LED driver circuit 120 and the printed circuit are disposed within the thermally conductive base.

In accordance with an embodiment of the present invention, the method 600 further includes the steps of applying the power supply 210 for providing an alternating current to the LED driver module, receiving the alternating current from the power supply and transforming the alternating current into an input voltage, and receiving the input voltage from the transformer 205 and the load stabilization LED driver circuit 120 being configured to produce varying levels of regulated current for the multiple LEDs 105.

In accordance with an embodiment of the present invention, the step of providing the LED package assembly includes providing a light chip having the multiple LEDs 105, providing the first flexible printed circuit 122 having an opening, and bonding the light chip to the first flexible printed circuit 122. The load stabilization LED driver circuit 120 performs the following steps detecting the transformer 205 to operate in stabilization mode, dimming input for detecting a dimming angle in order to ensure efficient loading factor of at least one device, and controlling a peak current during dimming. Consequently, the dimming angle is determined in order to ensure efficient loading factor is applied when the dimmer and transformer are at the critical operational curve.

Moreover, controlling a peak current during dimming provides protection to any overdriven of the electronic component and circuitry. Particularly, the light source is an MR-16 compatible light source and the thermally conductive base is a GU5.3 compatible base.

In accordance with an embodiment of the present invention, the step of providing the LED driver module includes connecting the load stabilization LED driver circuit 120 to a printed circuit, disposing the load stabilization LED driver circuit 120 and the printed circuit within the thermally conductive base, physically coupling the LED driver module to the heat sink 110, and electrically coupling the LED package assembly to the LED driver module.

In accordance with an embodiment of the present invention, the load stabilization LED driver circuit 120 is a thermal protection circuitry and the thermal protection circuitry is configured for linear dimming.

Therefore, the present invention provides the light source for producing variable illumination coupled to at least one device. The present invention detects and stabilizes the required loading factor in order for the light source to dim linearly from maximum to minimum light output brightness. Consequently, the dimming and compatibility is achieved with discrete component design. The present light source is compatible to leading, trailing and universal dimmers. Further, the present light source has compatibility to electronic and magnetic transformer.

The present lamp is compatible with most popular standard dimmers and transformer that are available in the market. In operation, the dimming is truly linear. The present invention provides reliable thermal saturation curve. Moreover, the lamp temperature meets safety standard and EMC requirement without any active cooling system such as fan. Furthermore, the lamp has standard fitting which is compatible to ANSI standard requirement. The present invention is based on the in-depth understanding of the characteristic of standard dimmers and transformers which are designed for halogen.

Accordingly, while there has been shown and described the preferred embodiment of the invention is to be appreciated that the invention may be embodied otherwise than is herein specifically shown and described and, within said embodiment, certain changes may be made in the form and arrangement of the parts without departing from the underlying ideas or principles of this invention within the scope of the claims appended herewith.

1. A light source for producing variable illumination coupled to at least one device, said light source comprising:
a light chip assembly including:
a plurality of LEDs on a silicon substrate;
a heat-sink coupled to said light chip assembly, said silicon substrate being coupled to an inner core region of said heat-sink via a thermally conductive adhesive;
an LED driver module including: a housing; a load stabilization LED driver circuit within said housing, said load stabilization LED driver circuit being configured to drive said light chip assembly; a printed circuit coupled to said load stabilization LED driver circuit; and a power supply for providing an alternating current.

2. The light source as claimed in claim 1, wherein said LED driver module further comprises:
a transformer for receiving said alternating current from said power supply and transforming said alternating current into an input voltage, and said load stabilization LED driver circuit being electrically coupled to said transformer for receiving said input voltage from said transformer and producing varying levels of regulated current for said plurality of LEDs.

3. The light source as claimed in claim 2, wherein said load stabilization LED driver circuit detects said transformer to operate in stabilization mode, and said load stabilization LED driver circuit includes a dimming input, said dimming input detecting a dimming angle to ensure efficient loading factor of at least one device, and controlling a peak current during dimming.

4. The light source as claimed in claim 1, wherein said light chip assembly further comprises a voltage booster printed circuit coupled to said silicon substrate and said voltage booster printed circuit is electrically coupled to said load stabilization LED driver circuit.

5. The light source as claimed in claim 1, wherein said light chip assembly further comprises a transducer coupled to said power supply and said transformer.

6. The light source as claimed in claim 1, wherein said load stabilization LED driver circuit is a thermal protection circuitry, said thermal protection circuitry being configured for linear dimming.

7. The light source as claimed in claim 1, wherein said load stabilization LED driver circuit is operated in the range of lighting intensity between 3% and 100% brightness.

8. The light source as claimed in claim 1, wherein said light source generates luminous efficacy greater than approximately 500 lumens.

9. The light source as claimed in claim 1, wherein said load stabilization LED driver circuit comprises a plurality of driving components disposed upon a first flexible printed circuit.

10. The light source as claimed in claim 1, wherein said heat sink comprises an MR-16 compatible heat sink.

11. The light source of claimed in claim 1, wherein said housing comprises a GU5.3 compatible base.

12. The light source as claimed in claim 5, wherein said transducer is an indicator lamp.

13. The light source as claimed in claim 1, wherein a power consumption of said light source is approximately 10 watts.

14. The light source as claimed in claim 1, wherein said at least one device is selected from a group consisting of dimmers, and transformer.

15. The light source as claimed in claim 1, wherein said light source has a compatibility of about 80% to said at least one device.

16. The light source as claimed in claim 1, wherein said load stabilization LED driver circuit has a power factor of about 0.95.

17. A method for forming a light source for producing variable illumination coupled to at least one device, said method comprising the steps of:
providing an LED package assembly having a plurality of LEDs disposed on a silicon substrate electrically coupled to a first flexible printed circuit;
bonding said LED package assembly directly to a heat-sink via a thermally conductive adhesive;
providing a LED driver module having a load stabilization LED driver circuit on a printed circuit, said load stabilization LED driver circuit and said printed circuit being disposed within a thermally conductive base;
applying power supply for providing an alternating current to said LED driver module;
receiving said alternating current from said power supply and transforming said alternating current into an input voltage; and
receiving said input voltage from said transformer and said load stabilization LED driver circuit being configured to produce varying levels of regulated current for said plurality of LEDs.

18. The method of as claimed in claim 17, wherein step of providing said LED package assembly comprises:
providing a light chip having said plurality of LEDs;
providing said first flexible printed circuit having an opening; and
bonding said light chip to said first flexible printed circuit.

19. The method of as claimed in claim 17, wherein said load stabilization LED driver circuit performs the following steps:
detecting said transformer to operate in stabilization mode;
dimming input for detecting a dimming angle to ensure efficient loading factor of at least one device; and
controlling a peak current during dimming.

20. The method of as claimed in claim 17, wherein said light source is an MR-16 compatible light source and said thermally conductive base is a GU5.3 compatible base.

21. The method of as claimed in claim 17, wherein step of providing said LED driver module comprises:
connecting a load stabilization LED driver circuit to a printed circuit;
disposing said load stabilization LED driver circuit and said printed circuit within said thermally conductive base;
physically coupling said LED driver module to said heat sink; and
electrically coupling said LED package assembly to said LED driver module.

22. The method of as claimed in claim 17, wherein said load stabilization LED driver circuit is a thermal protection circuitry and said thermal protection circuitry is configured for linear dimming.

23. The method of as claimed in claim 17, wherein said at least one device is selected from a group consisting of dimmers, and transformer.
